(19) United States
(12) Patent Application Publication
(10) Pub. No.: US 2012/0218254 A1
(43) Pub. Date: Aug. 30, 2012

(54) DATA VISUALIZATION DESIGN AND VIEW SYSTEMS AND METHODS

(75) Inventor: Christian Olaf Abeln, Odakra (SE)

(73) Assignee: MICROSOFT CORPORATION, REDMOND, WA (US)

(21) Appl. No.: 13/036,741

(22) Filed: Feb. 28, 2011

(51) Int. Cl. G06T 15/00

(52) U.S. Cl. 345/419

(57) ABSTRACT

Interactive data visualization features are provided, including three-dimensional (3D) visualization features and functionality, but the embodiments are not so limited. An exemplary method includes a declarative process of defining and using 3D data visualizations where visual appearance, states, and/or interaction options are based in part on an associated visualization model and/or measures of data. An exemplary computing architecture includes a number of components configured to provide declarative visualization design, interaction, and/or viewing features. Other embodiments are included and available.

### BACKGROUND

Important business decisions often revolve around comprehension of complex data sets in the context of some business goal. For example, a company may use database and spreadsheet applications to track profitable and unprofitable assets over a particular calendar year using multidimensional sets of data that may include partner data, customer data, or other information. As one example, a user may use a graphing application to view a projected data trend in attempts to understand the highly complex nature of a vast number of values to track or plot. However, many of the available applications are limited to pre-set interface control types, limited graphical options, and static user interaction features.

The concept of business data driven visual states and interaction has been widely explored for the constrained two-dimensional (2D) visualization space. For example, the number of measures that can be shown to a user and interacted with are generally limited in pure 2D visualizations to color, pattern, shape, and placement. Fixed, defined three-dimensional (3D) visualization models have been attempted which provide more rich features than a 2D visualization. However, the current 3D visualization models do not provide a declarative model and approach to define and use 3D data visualizations driven by measures of data.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments provide interactive data visualization features, including rich interactive three-dimensional (3D) visualization features and functionality, but the embodiments are not so limited. In an embodiment, a method includes a declarative process of defining and using 3D data visualizations where visual appearance, states, and/or interaction options are based in part on an associated visualization model and/or measures of data. In one embodiment, a computing architecture includes a number of components configured to provide declarative visualization design, interaction, and/or viewing features. Other embodiments are included and available.

These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 is a block diagram of an exemplary system providing visualization features and functionality.

FIG. 2 is a flow diagram illustrating an exemplary process of providing interactive 3D visualizations.

FIGS. 3A-3B are block diagrams of an exemplary computing environment.

FIG. 4 is a flow diagram illustrating an exemplary process of providing interactive 3D visualizations.

FIG. 5 depicts an exemplary visualization designer interface.

FIGS. 6A-6F depict a number of exemplary surfaces that can be provided as surface objects for use in an interactive 3D visualization.

FIG. 7 depicts a number of exemplary stencil or visual elements that can be provided as stencil objects for use in an interactive 3D visualization.

FIGS. 8A-8C depict aspects of an exemplary interactive 3D visualization provided as a result of a declarative design process.

FIG. 9 is a block diagram illustrating an exemplary computing environment for implementation of various embodiments described herein.

### DETAILED DESCRIPTION

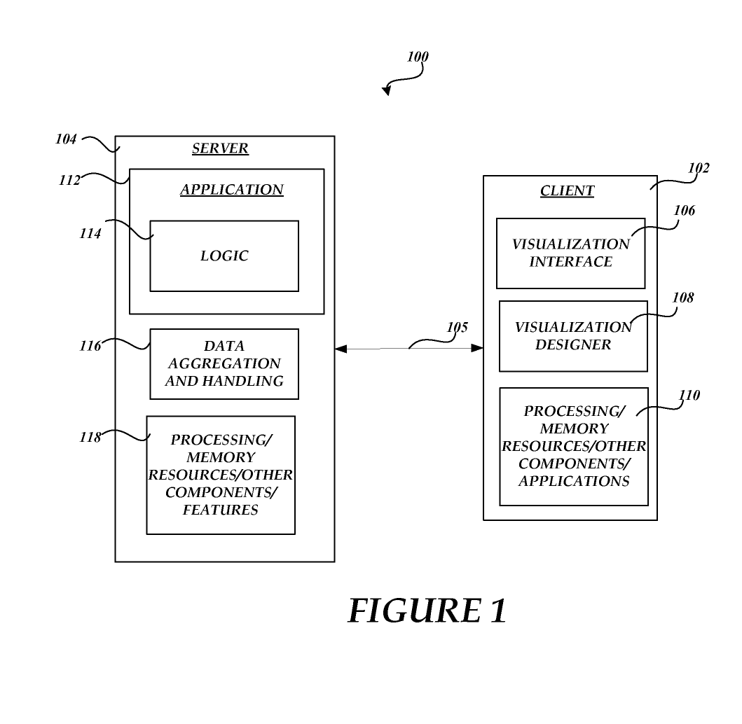

FIG. 1 is a block diagram of an exemplary system 100 that includes data processing, video processing, memory, and/or other components that provide data visualization features and functionality, but the embodiments are not so limited. As described below, components of the system 100 can operate to provide interactive three-dimensional (3D) data visualizations that can be used for a variety of end-uses, including providing interactive visualization scenes for use in analysis of complex data sets. For example, components of the system 100 can operate to provide an interactive visualization representation for analyzing different types of data by providing additional interactive controls and visual effects to gain further insight using different data perspectives to identify data outliers, actionable items, and/or other relevant visualization events.

In one embodiment, components of the system 100 provide functionality as part of a declarative model of defining and using 3D data visualizations where visual appearance, states, and/or interaction options of the visual node elements are driven by measures of data. For example, a data visualization can be designed to provide an interactive 3D interface using aggregations of data, wherein stencil objects and/or links can be displayed, characterized, and/or animated based on aspects of the aggregated data. Stencils and other features of a visualization can be interactively manipulated and/or transitioned based in part on user input and/or underlying business transactions associated with the aggregated data.

The declarative model of an embodiment enables a visualization designer to declaratively define and execute a 3D business data bound, interactive visualization that defines a 3D scene based in part on a selectable floor or surface and a number of visual node elements bound to a selection of business data. The declarative model of one embodiment provides an extensible set of surface models, scene elements, and/or scene layout engines. As described below, the declarative model provides functionality that enables specification of surface and scene elements, wherein the model connects or links surface and scene elements to data, such as aggregated business data for example, such that measures of the aggregated business data control visual state, placement, and/or appearance, but is not so limited.

Components of the system 100 can be used to declaratively provide defined 3D visualization interfaces for use in visualizing data. Typical types of business data may include one or more lists of data entities of one or more types, wherein each entity may have multiple properties and each property value can be of static or calculated nature. Entities may be in a directed link relation to other entities of the same or another type from the same or another list of entities. Sample business data entities include, but are not limited to, “Customers”, “Documents”, “Sales Orders”, “Purchase Orders”, “Production Orders”, “Transfer Orders”, “Items”, “Material reservations”, etc.

As described below, business and other data can be visualized using a 3D data visualization that includes a previously declared interactive interface depicting a scene on top of a floor/surface type and special visualization characteristics. Sample surface types include, but are not limited to, a timeline/calendar with the date displayed along one perspective to visualize entities according a date/time measure, a map like special representation (e.g., building map, an area under observation, an exploded schematic drawing, topographic map, etc.), a geometric 2½ or 3D object that allows the representation of entities according to one or more measures (e.g., a circular surface with slices for a category measure and distance from center for a value measure of entities), etc.

Designed visualizations can be used to visualize entities in the context of declaratively defined surface and visual node elements or stencil objects. For example, business data entities can be represented by visual node elements located in a visualization scene according to characteristic of an associated surface and/or data of one or more data sources. Each visual node element can be configured to reflect one or more measures as part of a visual representation. For example, a visual node element can be configured as a transparent flask object, wherein the filling level and color of the filled portion of each transparent flask can be used to represent measures of underlying business data. As another example, a visual node element can be configured as a fixing pin, wherein the size, color, and/or shape of the fixing pin head, and/or the pin needle length can be used to represent additional measures of underlying business data.

Other exemplary visual node elements can include 3D representations of physical objects, wherein size, color, and/or position of the whole or a sub-element can be defined using a value that corresponds with a business entity or other measure. Visual aspects that reflect individual measurements of an entity may be adjustable from within the visualization through different interaction mechanisms, including, but not limited to: draggable handles that adjust height and/or filling levels; draggable handles used to move an object on a surface (e.g., rescheduling on a calendar surface, moving in distance to the center, moving in constant radius around a etc.); establishing link relations between visual nodes using a stencil link, etc.

As described below, in an embodiment, components of the system 100 provide a visual model to analyze a number of data measures in the context of an interactive 3D data visualization that includes a pre-designated surface and/or visual node elements of stencil objects that are used to dynamically reflect aspects of data, including changes to the data and/or visualization. The system 100 of one embodiment includes a client server data communication pipeline to provide interactive modification of transactions in time (e.g., rescheduling an order, shipment, stock purchase, sale, etc.) and amount, as part of visualizing consequences using a graphical animation using visual node elements as part of illustrating data changes. The 3D data visualization representation can be used to visualize interactive user changes, which can be aggregated as feedback over a communication pipeline to associated logic (e.g., business logic).

As described below, the system 100 of an embodiment includes 3D data visualization features integrated with underlying business logic. For example, an enterprise can use a resource planning computing architecture to aggregate, organize, and provide insight to business data, including using interactive 3D data visualizations and associated controls to analyze aspects of the aggregated data. In one embodiment, 3D data visualization representation and/or features can be provided as part of a program add-in or other component, including one or more server-side objects, a codeunit for data processing, and/or other visualization features.

In an embodiment, components of the system 100 provide 3D design and/or viewing functionality, as part of providing an interactive visualization environment. In one embodiment, the system 100 includes two runtime features, a visualization design component to declaratively design interactive 3D visualizations and an interactive viewing component or viewer to view and/or interact with declaratively designed 3D visualizations. The design and viewing components can be configured to run stand-alone or hosted within other desktop or web applications.

The system 100 of an embodiment includes and/or uses a library of surfaces and/or a library of stencils, wherein stencils can be used to populate a surface according to an associated visualization design definition. One or more data sources can be used as part of declaratively designing 3D data visualizations using the design component, wherein each data source can be used in part to define the number, location, and how stencil objects populate an associated visualization surface. A visualization surface of an embodiment exposes a binding contract that is fulfilled by the design component. In one embodiment, the binding contract exposes a number of layout properties which each stencil coupled to an associated surface inherits. An exemplary visualization surface can include a 3D scene (e.g., geometry, materials, textures, behaviors, interactions, etc.); or a two-dimensional (2D) interactive scene, rendered as a texture on a standard surface object (e.g., a plane) or custom 3D surface object.

In one embodiment, a declarative design interface is configured for use in designing and providing data visualizations, including creation and/or use of active surface and/or stencil libraries as part of the design process. The declarative design interface of one embodiment provides a basic visualization plane, selectable surfaces, selectable stencils, and/or available data sources, and uses interactive inputs, such as pen, mouse, touch, keyboard, etc. for panning, rotation, zooming, and other visualization operations. The declarative design interface of one embodiment features a custom scene 3D model, and allows custom surface floor models, including custom stencil objects. As described above, an interactive visualization viewing component or viewer can be used to render the declaratively designed visualization at runtime and displayed using a display.

As shown in FIG. 1, the system 100 of an embodiment includes a client computing device or system 102 (referred to as client 102) (e.g., desktop, laptop, handheld, etc.) and a server 104, but is not so limited. The client 102 of an embodiment includes a visualization interface 106 including a visualization design component or visualization designer 108, and processing, memory, and/or other application resources 110, including a cache for storing visualization data and other information. In one embodiment, the server 104 and client 102 use data and view models to provide an interactive 3D data visualization using the visualization interface 106 to provide a viewing platform for using and interacting with the visualizations. The client 102 can also include other applications and/or input/output features, such as data processing, video processing, and/or networking features as examples.

As described below, the visualization designer 108 of an embodiment includes a declarative design model that can be used to declaratively design interactive 3D visualizations, including various surface and visual node elements. It will be appreciated that a computer display can be used to display the visualization interface 106 including associated interactive 3D visualizations. The client 102 of one embodiment can interact with the server 104 using a communication channel 105 to provide dynamic interactive visualization features using multidimensional data aggregations. The communication channel 105 of one embodiment includes one or more communication channels or ports to exchange information between the client 102 and server 104.

The server 104 of an embodiment includes a multidimensional data resource planning application architecture, which can include physical and virtual components and configurations. As shown in FIG. 1, the server 104 of one exemplary embodiment includes application 112 including logic 114, a data aggregation and handling component 116, and/or other components and features 118. For example, the server 104 can include a number of networked components to efficiently process and handle data, metadata, and other information using various data aggregations to provide visualization data for consumption by client 102, including processing interaction information associated with user interactions with a particular visualization. In one embodiment, the server 104 can receive data changes including changes associated with updated and/or modified data resulting from a user interaction from the client 102 over the communication channel 105.

Data communication between the client 102 and server 104 of one embodiment uses a data exchange mechanism composed in part using visualization definitions of an underlying interactive visualization representation or package. The system 100 of an embodiment provides an interactive visualization interface that enables users to visually analyze and interact with business entity and other data from different perspectives using portions of a 3D visualization to quantify different types of data simultaneously in a comparing manner. The visual representation translates into a mental model for users when performing certain tasks using data. The user can populate an interactive visualization data representation with data based in part on selection of one or more types of display data. For example, a user can populate an interactive visualization data representation with booked transaction data, changes data, and/or forecast data, whether set by associated business logic or modified by an end user.

Exemplary data visualizations can be used to picture aspects of a business by providing an interactive 3D visualization perspective for select business data and data dependencies as part of examining fundamentals of a business, including state and trend data. Exemplary 3D visualization features enable users to drill-down into aspects of aggregated data to provide intuitive, ad hoc analysis, providing knowledge to act based in part on defined measures. Users can use interactive features of an exemplary 3D visualization to visualize impacts/results of actions, including dependency assessments as part of predicting an outcome of a course of action.

Exemplary use of components of the system 100 can provide data visualization interfaces for gaining insight into business data, such as trends and questionable products and/or services by viewing business data from different perspectives and interactive states. As an example, a user can use an interactive 3D graphical data representation that includes visualization objects associated with a surface and stencil object model to visualize aspects of large aggregations of data based in part on a number of visualization measures. The visualization features can be used to interactively track dynamic data changes using corresponding visual node elements as part of providing an effective visualization experience. The graphical data representation interface of one embodiment provides direct access to relevant user interface (UI) pages so that users can act on the business data object behind a visualization portion or step.

In one embodiment, the system 100 includes a dedicated server including a .NET-based Windows Service application that communicates with one or more database servers (e.g., SQL server databases), including a communication framework protocol to process client requests. In an embodiment, business logic runs on the dedicated server instead of on the client. In another embodiment, client and server components cooperate in accordance with implemented business logic. The dedicated server (e.g., MICROSOFT DYNAMICS server) provides an additional layer of security between visualization clients and any data sources, such as a database server or servers for example.

In one embodiment, the system 100 uses a data format for visualization presentations using an extensible markup language (XML) definition. For example, a data builder feature (e.g., .NET) can be used by integration code to build the data in a strongly typed way. In such an embodiment, the visualization controls provide events for selection and activation of an item. The integration code can handle events and provide new data when necessary. For example, an extensible application markup language (XAML) control can be used by the integration code to control aspects of a data visualization.

An exemplary computing system includes suitable programming means for operating in accordance with a method of providing a visualization interface and controls for interacting with visualization data. Suitable programming means include any means for directing a computer system or device to execute steps of a method, including for example, systems comprised of processing units and arithmetic-logic circuits coupled to computer memory, which systems have the capability of storing in computer memory, which computer memory includes electronic circuits configured to store data and program instructions. An exemplary computer program product is usable with any suitable data processing system.

As one example, a visual application user can use embedded 3D interactions elements, like a slider on a select stencil object, to change supply quantity, or move forward or backward in time to suggest a rescheduling action. Changes can be transmitted back to application code for processing and validation, where the changes can be applied or rejected. Users can interact with the visualization by zooming, scrolling, manipulating adjustable visualization portions, including reverting changes, adjusting stencil objects including visual change indication components of each stencil, etc.

A visualization environment of an embodiment includes a number of components, including server resources and at least one client application coupled to at least one data source. For example, server resources can include at least one application, such as a resource planning application for example, a view model, and a data model used in part as a data building system or data builder. The client of one embodiment includes an add-in component, view model, data model, and a visualization component. The client and/or server can also include and/or have access to one or more stencil and surface libraries. In one embodiment, the client and server communicate using communication ports (e.g., extensible markup language (XML) port(s) and a .NET data set(s)), including data and schema information. Correspondingly, visualization driven data can be composed and consumed using a number of the communication ports.

Declaratively designed 3D visualizations can be reused across multiple application scenarios. For example, an interactive 3D visualization can be provisioned and used as part of a resource planning application to deliver an interactive and/or modifiable visual model including declaratively defined components including surface, stencil, command, and/or event models. In one embodiment, a resource planning or other application and/or system can include integration code to host a visualization environment in an associated user interface (UI), including the communication and/or processing of transaction data, receiving, and processing changes and updated changes for an associated visualization. For example, change transaction communications can be applied on the server-side after a user has affirmatively applied changes in an associated visualization.

In an embodiment, a visualization environment includes a set of application objects that implement data communication over XML ports, thereby removing a need for server side extension objects to impart data handling. Integration objects contain logic to aggregate transaction events and populate a visualization data model. The integration objects also contain logic used to receive updated changes and apply the changes to respective business transactions. In one embodiment, a visualization add-in component can be configured to use a schema contract defined in part by the add-in code to support command and data documents. In one embodiment, a data document that contains information influencing the view and/or table of events to be visualized, and/or a command document that contains one or more of the commands that the visualization understands, can enable a host of the visualization to control all or individual interactive data points in the same way as the user can.

A visualization add-in can be configured to communicate events to a host using a trigger or trigger event. Each event of an embodiment can be characterized by a message ID to characterize the type of event and can include additional string data to provide context information used by the host to process each event. Declaratively designed 3D visualizations can be used with any number of client devices and/or systems to provide visual analysis tools for use in comparing multiple scenarios, including providing visual node or stencil elements mapped to the underlying data providing and validation components. For example, a partner user can select a previously designed and provisioned 3D visualization as a starting point when tailoring the provisioned 3D visualization with additional data values associated with new business logic as part of identifying potentially significant business events and/or parameter adjustments for a particular business scenario. As described below, changes can be shown visually and aggregated as feedback to associated business logic.

An application programming interface (API) architecture can include a number of public APIs for use in part to integrate the various visualization features into further application and personal/particular business setting/particular user setting (e.g., finance, health, inventory, yearly prognosis, etc.) scenarios. For example, a visualization interface can be provided in part using one or more of the public APIs to render and re-render an interactive 3D visualization displayed using a client application, wherein classes and interfaces are configured to be independent of a display target or client.

In one embodiment, a command document can be used to control an underlying visualization. The command document can be illustrated using a string in the following exemplary format:

‘Command:’+[Command]+‘,’+[RefNo]+‘,’+[Parameter]

This format assumes that neither [Command], nor [RefNo], nor [Parameter] may contain a ‘,’ character. In one embodiment, RefNo is a unique application defined value used to reference a document that represents a transaction.

In one embodiment, a visualization add-in component can use one or more events as part of rendering a 3D visualization. For example, a trigger (e.g., OnControlAddIn trigger) of a hosting field on a page can be called with one or more event types. A changed data event can be sent for each user interaction that changes some aspect of a visualization representation. For example, event ‘100’ can be used to track a user drag operation with an interactive data point, and/or through actions in the point/free area context menu. In one embodiment, an event ‘100’ can be fired when a user changes a data point interactively (e.g., dragging or through context menu) and/or a first time an interactive series is provided and/or displayed. In one embodiment, a data parameter of an event contains only the changes and the references to the changed or adjusted data points, and does not contain the data points that have not been changed from either original amount or original date and are not a new supply. The data contains all of the changes, regardless whether the changes resulted from an end user or have already been sent as transactions for an associated visualization.

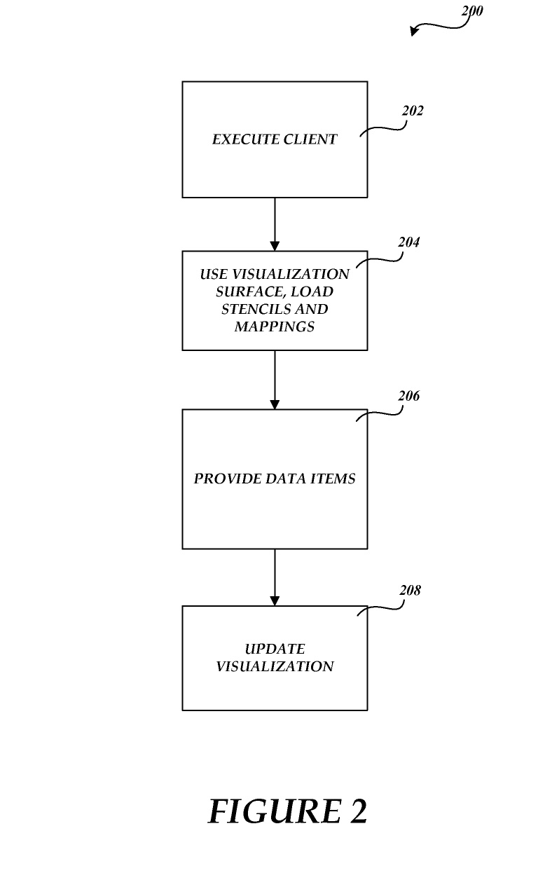

FIG. 2 is a flow diagram illustrating an exemplary process 200 of providing interactive 3D visualizations. In one embodiment, the process 200 includes two runtime solutions: a visualization design environment and an interactive viewing environment. The visualization design environment can be used to design interactive 3D visualizations which can be viewed using the interactive viewing environment. The viewing environment provides for use and/or tailoring of a declaratively designed 3D visualization according to some particular visualization preference or model.

At 202, the process 200 begins when a client application is executed to provide a visualization interface. For example, an integrated visualization design application of a client device can be used to design and/or view interactive 3D visualizations. At 204, the process 200 operates to create, use, and/or import a visualization surface, including loading associated stencil libraries and stencil-to-data node mappings. At 206, the process 200 operates to provide data items within a select interactive 3D visualization, including automatically rendering aspects of visual node elements of a visualization scene based in part on a user's input or command.

At 208, the process 200 operates to update the 3D visualization based in part on user interactions and/or new or modified data. For example, a user may adjust different data points of a 3D visualization to gain insight into how certain changes affect visual node elements or stencil objects which visually reflect types of changes made. The process 200 of one embodiment uses color, fill, and/or labeling features to dynamically reflect changes within a particular 3D visualization as a user interacts with visualization nodes. While a certain number and order of operations is described for the exemplary flow of FIG. 2, it will be appreciated that other numbers and/or orders can be used according to desired implementations and other embodiments are available.

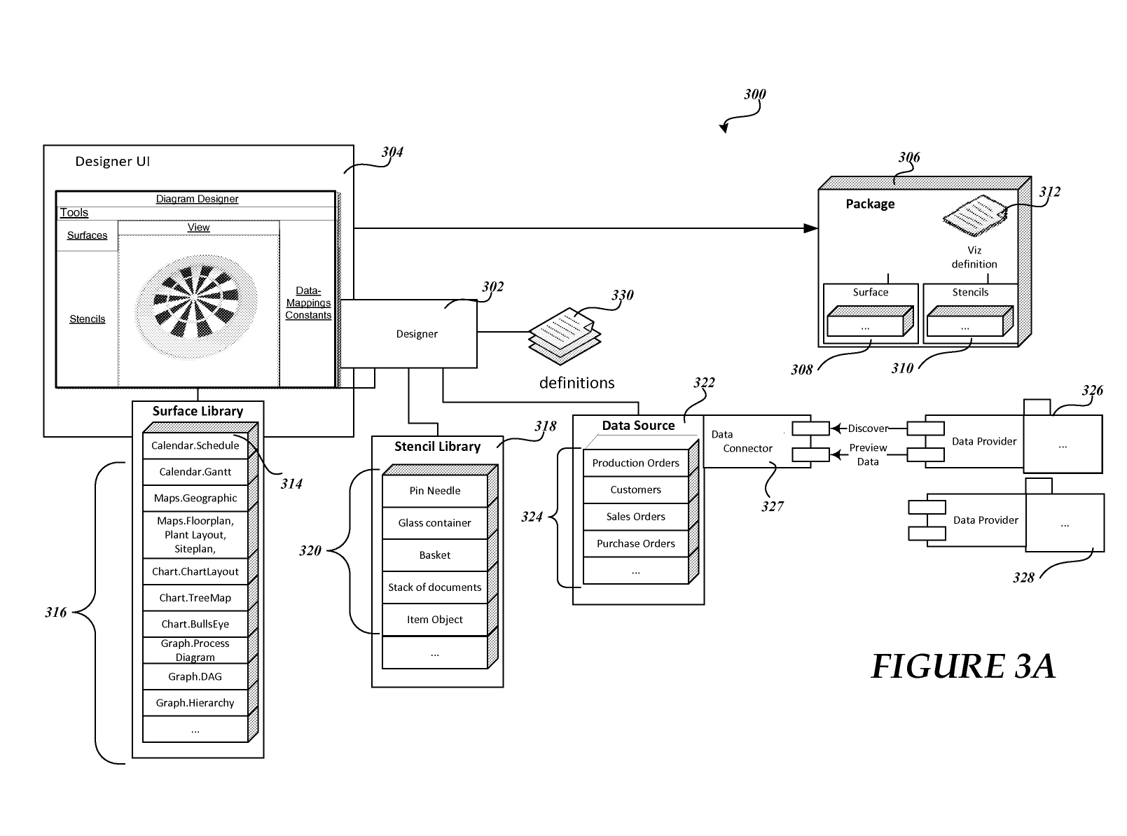

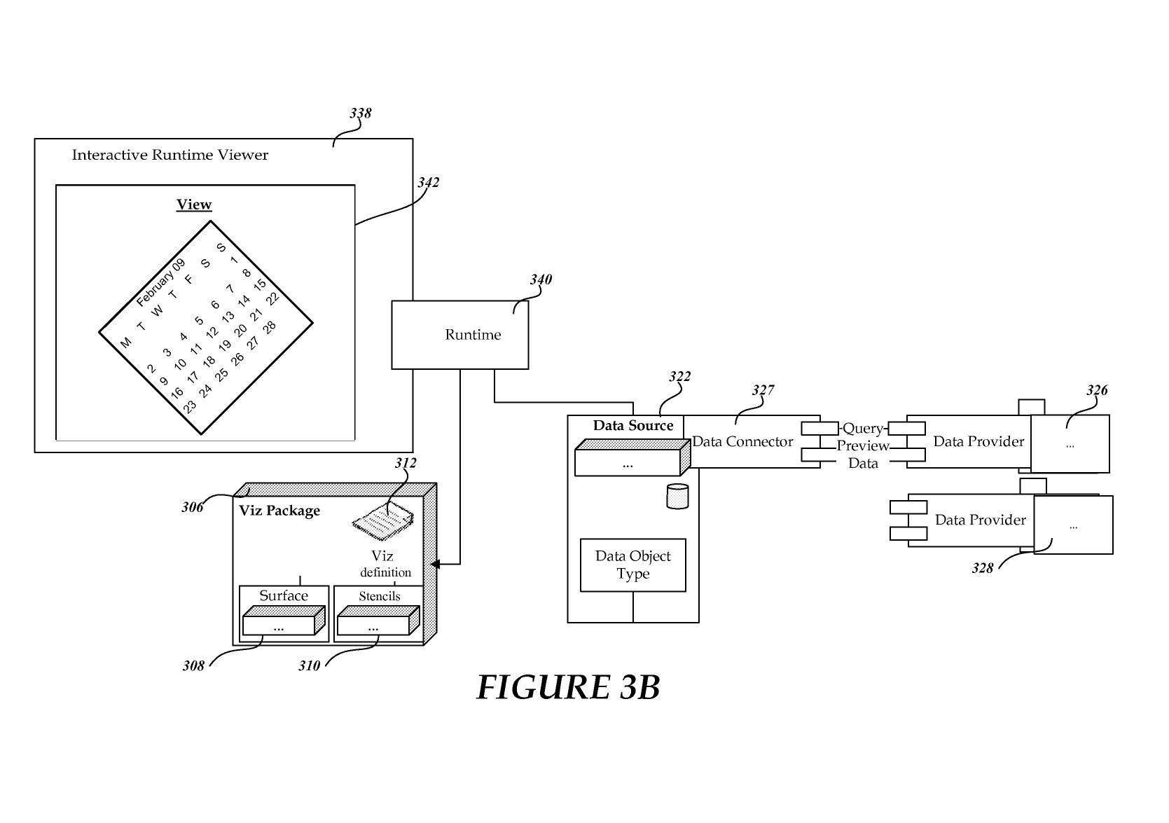

FIGS. 3A-3B are block diagrams of an exemplary computing environment 300 that includes design and viewing features as part of providing declaratively defined interactive 3D visualizations using a number of associated surface and stencil objects. As shown in FIG. 3A, the exemplary environment 300 of an embodiment includes a visualization designer 302 including an associated designer user interface (UI) 304 for use in declaratively designing interactive 3D visualizations. As described below, the visualization designer 302 includes a number of schemas used in part to generate a visualization package 306 that includes a declaratively defined visual scene including an associated surface 308, stencils 310, and visualization definition 312.

In an embodiment, exemplary schemas include, but are not limited to: data source definitions including data items, data item properties, filters, and/or other parameters; a generic two (2) way data communication mechanism from a business application to a visualization viewer or other visualization component; mappings of data item properties to visual properties; visualization definitions including a data source, data communication parameters, surface and stencil objects and the associated data item mappings; and/or visualization packages, wherein each package schema includes a visualization definition and surface and stencil libraries or links thereto.

The visualization package 306 of one embodiment includes a visualization definition 312, and a dictionary of surfaces and stencils used as part of providing a specific visualization experience. In one embodiment, the visualization package 306 can be packaged into an archive and transferred to a different machine. For each receiving machine or client, the surface and stencils of the package can be extracted and integrated into a local dictionary. Each surface and stencil can carry a unique identification and a version. In a local dictionary, the same surface and/or stencil of a certain unique identifier can reside in different versions.

With continuing reference to FIG. 3A, the exemplary environment 300 also includes a surface library 314 including exemplary surface objects 316, a stencil library 318 including exemplary stencil objects 320, a data source 322 including exemplary data objects 324 of various types. Surface objects can be used by a layout engine including defined layout control properties, and/or interaction options. Exemplary interaction options include, but are not limited to: move, open, select, size, remove, new, etc.; exemplary camera interactions can include, but are not limited to rotate, pan, zoom, etc.; exemplary device options can include, but are not limited to mouse inputs, touchscreen inputs, camera-based inputs, accelerometer-based inputs, etc.).

Stencil objects can be included with the visualization designer 302 and presented to the user designer. Each stencil object can include various characteristics including, but not limited to: geometries, textures, materials, behaviors, animations, transitions, visual properties (e.g., color, size, shape, etc.), interaction options (e.g., move, adjust level/amount, push, etc.), etc. Data object types include metadata, meta-metadata, data item attributes, relations, etc. Other data providers 326 and 328 can be discovered and used by components of the environment 300.

The visualization designer 302 can be run stand-alone or hosted within other desktop or web applications, and uses the surface library 314 and stencil library 318 as part of providing a declarative design tool for creating interactive 3D data visualizations. Stencil objects are used to populate an associated surface object according to a corresponding visualization design definition of the visualization definitions 330. As an example, as part of increasing business productivity, the visualization designer 302 can be used to access surface objects 316 from the surface library 314. It will be appreciated that the surface library 314 and/or stencil library 318 can be configured as local and/or remote resources. In one embodiment, management of the surface library 314 and/or stencil library 318 includes the addition, removal, and/or modification of surfaces and/or stencils, respectively.

The visualization designer 302 can be used to select an available surface from the surface library 314. Exemplary surface objects include, but are not limited to: Calendar: Schedule, Gantt, Timeline, etc.; Map: Geographic (e.g., Internet Maps: Country, Regions, Street level, Terrain, Satellite, etc.), Floor plan, Site plan (e.g., Warehouse, Casino, Production Floor); Chart: BullsEye representation, TreeMap representation, Step-line representation, Columns, etc.; Graph/Diagram: Directed Acyclic Graph, Hierarchy, Process flow, Functional diagram, etc. Once declared as a surface for a particular interactive 3D visualization, the selected surface exposes a binding contract to be fulfilled in the visualization environment. The binding contract of an embodiment exposes a number of layout properties which are inherited by each stencil of a declaratively designed 3D visualization.

Exemplary visualization scenes include interactive 3D scenes (e.g., geometry, materials, textures, behaviors, interactions, etc.) and interactive 2D scenes. For example, an interactive 2D scene can be rendered as a texture on a standard surface object (a plane for example) or custom 3D surface object. In one embodiment, the binding contract is a contract requirement exposed by the corresponding surface and stored in the visualization definition (e.g., visualization definition 312). As described below, a visualization viewer uses the binding contract in part to display the 3D visualization which includes proper connections and mappings for the layout.

As an example, assume a visualization designer used the visualization designer 302 to declaratively design a 3D visualization to include a factory floor model as a surface and a 3D machine visual (e.g., visual node element) as a stencil as part of visualizing a production orders data item type. For this example, the factory floor model (the surface) has location included as part of the associated binding contract. Thus, each data item used for a visual item on the surface needs to provide a location per the contract. For example, the data item may have a fixed location as part of its underlying data, or can calculate the location dynamically from other data (e.g., address lookup).

A data visualization designer can also use the visualization designer 302 to select at least one data source (e.g., data source 322) which is used in part to define the number, where, and how stencils are to populate an associated surface. Continuing this example, the visualization designer 302 can be used to select a data provider (e.g., providers 326 and/or 328) to provide or access a dictionary of available data items types (e.g. Customer, Sales Order, Sales Order Line, Item, etc.) using a data dictionary connector or data connector 327, wherein one or more of the available data item types can be selected and/or used for display on an associated surface.

In one embodiment, as part of a declarative design process, a stencil included in the stencil library 318 can be selected for each data item type. In another embodiment, an automated process can automatically suggest and/or populate stencil objects according to each data item type and/or associated surface. In one embodiment, a data filter can also be specified for each data item type. The visualization designer 302 can be used to select data item attributes for each data item type from a group of available data item attributes used for mapping to visual attributes of each stencil. The visualization designer 302 can also be used to select other selected data item types from a group of available relations for each data item type, including selecting a link stencil for each relation.

FIG. 3B depicts a block diagram of components used to view and/or interact with a 3D visualization. As shown in FIG. 3B, an interactive runtime viewer 338 uses a visualization runtime 340 to display a visualization view 342 associated with a declaratively designed 3D visualization defined in part by the contents of the visualization package 306. For example, an end-user looking to improve productivity can access an online resource that includes a number of available visualization packages that may be available to certain users or for purchase. The interactive runtime viewer 338 can be run stand-alone or hosted within other desktop or web applications and used to view and interact with declaratively designed interactive 3D data visualizations. For this example, the interactive runtime viewer 338 is operating with the visualization runtime 340 to display the 3D data visualization using the visualization package 306, data source 322, and/or one or more data providers 326, 328.

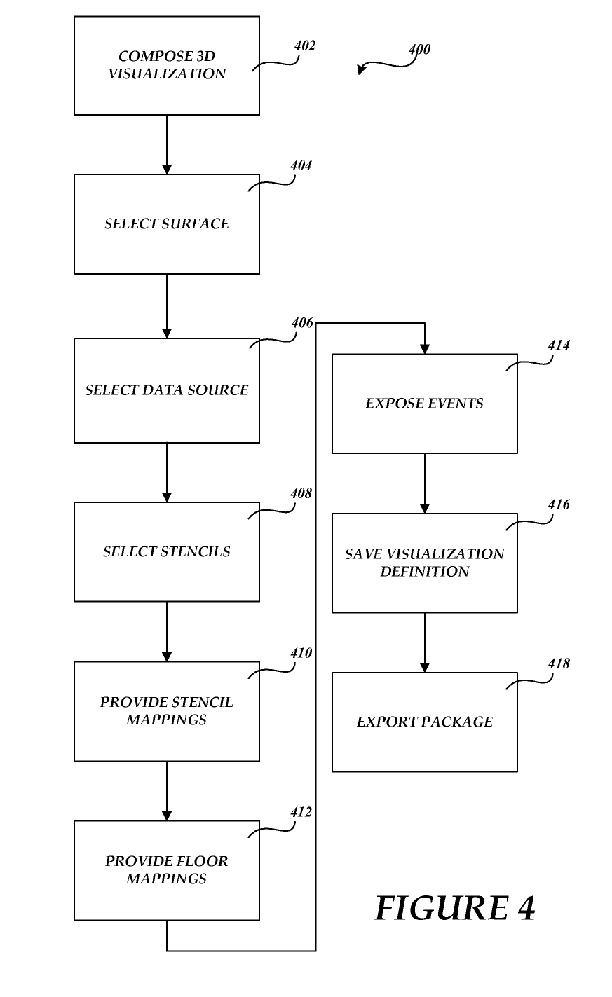

FIG. 4 is a flow diagram illustrating an exemplary process 400 of providing interactive 3D visualizations. At 402, the process 400 operates to compose a 3D visualization. For example, the process 400 at 402 can use a visualization designer application to compose a business visualization, such as by a production planner who wants the show the flow of a certain material from supply through production steps to final products, and delivery to customers.

At 404, the process 400 operates to select and/or define a surface or floor in which context associated data items are to be presented (e.g., a Process Diagram) for the 3D visualization. In one embodiment, a library of surface objects can be provided and used to populate the user visualization. For example, the production planner can use a surface library to select a surface that supports a graph layout (e.g., directed acyclic graph), including a date oriented floor layout for nodes and border regions for root and leaf nodes of the graph.

At 406, the process 400 operates to select a data source of a coupled system (e.g., Dynamics NAV server), including selecting data objects with associated data attributes and/or relations. For example, a designer can provide a design input to show a data object “Production Orders”, according to a number (n) to one (n:1) relation Input of the data object “Item Reservation” and a one to a number (n) (1:n) relation Output of the data object “Item Reservation”. Exemplary data attributes for the data object “Production Orders” include “Start Date”, “End Date”, “Planned Output”, “Input Demand”, “Supplied Input”, “Priority”, etc. and includes other relations such as “WorkCenter”, “Worker”, etc.

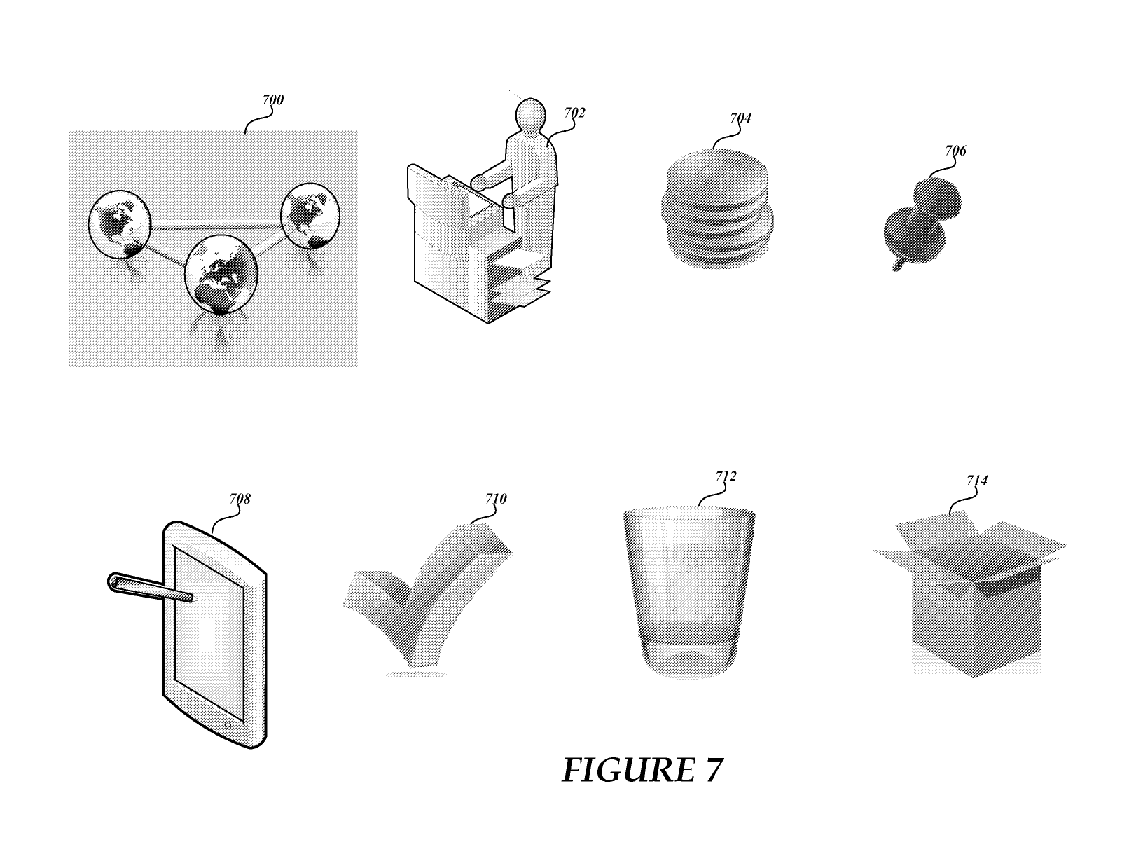

At 408, the process 400 operates to select stencils, including assigning selected stencils to data object types and selecting and assigning link stencils to data object relations (see for example stencil 700 of FIG. 7). For example, the 3D visualization designer can use a stencil library to select a 3D stencil of a production machine for the data object “ProductionOrder”. Continuing the example, the designer can select a 3D link stencil depicted as a thin flexible pipe or hose for the relation “Item reservation”.

In one embodiment, after selecting a surface and/or stencil, the designer application can be configured to define constant values on the properties exposed by the surface and/or stencil(s) as part of delivering basic visualization capabilities. A surface may support several layout behavior variations. For example, a calendar surface arranges visual nodes in one axis along the time line, but for the other axis, the designer may prefer layout behaviors which place nodes in different ways, such as a layout that reduces crossings of relation stencils, a layout that places visual items equally spaced, a layout that groups visual items of the same or similar kind together, etc.

At 410, the process 400 operates to provide stencil mappings for the data items. For example, the designer can declaratively define stencil mappings by selecting data object attributes which includes mapping the data object attributes to visual stencil attributes. For example, a selected stencil depicting a production machine exposes a number of visual attributes, wherein aspects of the visual appearance of the selected stencil are adjusted based in part on connected value providers to the visual attributes. As an example, at runtime, the production machine visual graphically depicts a material input sledge in proportionally colored material when the attributes InputMax and InputActual of the sample production machine stencil are connected to the attribute Input Demand and actual Supplied Input of the data item Production Order.

Additional information may come from production machine configurations, such as the capacity of a production machine. In one embodiment, a business application delivers the information joined into a bound data object. For the example of a Production Order, the business application can retrieve the capacity from a machine configuration for the Production Machine ID stored with the Production Order, and make the capacity available through the data item Production Order. Thus, as shown by this example, a designer can map Capacity to a visual attribute of the stencil that influences the rendered size.

At 412, the process 400 operates to provide floor or surface mappings for the data items. For example, the designer can declaratively define surface mappings by selecting data object attributes for each layout property for inheriting by stencils coupled to a defined surface. For example, each visualization surface can be configured to expose a number of layout properties that use values for each stencil/data object to be shown as a visual item on the surface. As an example, calendar and timeline surfaces use a value for a date attribute for the placement of each visual item (e.g., a calendar or timeline stencil). In one embodiment, a visualization design interface can be configured to display all attributes which a layout surface introduces into visual items as part of a special section of attributes for mapping. Attributes introduced by a surface or layout can be mandatory or optional in terms of mapping to a data item attribute.

At 414, the process 400 operates to expose a number of events associated with the 3D visualization, including exposing selected stencil events and surface events to be fired as triggers to a coupled or integrated business application. In one embodiment, each event from a visual item can carry or include a unique identifier of the data item that the visual item represents. A surface and any visual item, such as stencil objects can expose events. For example, an event might include a change notification to reflect that a user has dragged a visual item on the calendar surface to a different place in order to change the respective Date on the data item. A visualization designer can select the events to handle in business logic using a declarative design interface. For each selected event, the designer can choose whether the event is to be sent as a non-blocking notification event, a blocking event, or both.

Non-blocking notification events of an embodiment can be sent in a queue of all non-blocking notification events to business logic. Business logic can use the events to log a state. For example, the business logic can log a state in order to understand that the user has changed data in a visualization. In such a case, business logic knows that the data from the visualization needs to be processed and potentially converted into business transaction after the user has finished working in the visualization. Blocking events of an embodiment can be used to allow business logic to run needed validations and return a value that indicates for example whether a change from a user is acceptable or needs to be reverted by the visualization. In such a reversion case, the business logic can also return a message to be displayed in the visualization to the user.

At 416, the process 400 operates to save the declaratively designed 3D visualization configuration as part of a visualization definition. In one embodiment, a visualization definition is configured to contain the visualized data objects including filters, a surface selection with constant properties, a stencil or visual item selections for data item types with constant properties, including mappings of visual item attributes to data item attributes, stencil selections for data relations with constant properties, including mappings of visual item attributes to relation/data item attributes, and/or event selections.

At 418, the process 400 operates to export the declaratively defined visualization as part of a visualization package. The visualization package of one embodiment includes a visualization definition, a selected surface and associated stencils. For example, an exported visualization package can include a visualization definition, a library of pluggable surface and stencil objects, and package metadata (e.g., Vendor, Name, Package Version, Target System Version, Description, Documentation, Vendor signature, etc.). In other embodiments, the process 400 can include additional process steps including visualization integration and/or distribution operations.

For example, as part of an integration operation, a partner can integrate a generic visualization display runtime into a business application, including defining the context specific data filters, and writing trigger code that handles exposed visualization events in business logic. As a distribution operation example, a partner can distribute a declaratively designed visualization package, wherein an associated visualization definition can be registered on a server, and contained surface and stencil objects can be imported into surface and/or stencil libraries of each client tier. As an example, a partner can distribute a business application using a generic visualization display and interaction runtime, wherein a page containing a visualization that references a certain visualization definition can be registered on a server that is used in part to process operations associated with the business application. The distribution can be also provided as an on-demand feature.

Regarding mapping operations above, it will be appreciated that various mapping methods can be used according to particular visualization implementations. For example, each visual item attribute can be declared as mandatory or optional. Without a mapping, a default value from the visual item can be used. For some visual item attributes, a value range can be defined: for example the InputActual might have a range of [0 . . . 100]. A value range is used by the visual item to visualize a value in relation to the full value range. For other attributes, value ranges may not be relevant, for example a Unique Identifier attribute that is mapped to the ID of a data item.

Native value range mapping defines that a valid value range for a data item attribute is captured in an attribute on the metadata that describes the data item attribute (for example has the Supply property a value range of 0 . . . 100%) such that the mapping will be implemented accordingly. Automatic value range mapping can be used if the value range is not defined in the metadata that describes the data item attribute, the full data set can be consulted to identify a value range. For example, if the value range of the Capacity attribute in all displayed data items of a visualization is 10.000 to 50.000, the value range can be mapped on the mapped visual attributes of each stencil, including mappings associated with any associated link stencils.

Manual mapping enables explicit specification of an expected data range on a mapping definition. If values appear in for a data item attribute, that fall out of this range, the Max/Min value of the explicitly defined range can be used in the visualization instead of the real range. Non-linear mapping in some cases can be used rather than a default mapping of values of a data item attribute to visual attributes. For example, non-linear mapping enables a user to specify a logarithmic, parabolic, and/or other mapping behavior. Custom mapping functions can be provided as Add-ins to the design and rendering environment.

As an example of using a declaratively designed visualization, wherein use of the visualization parallels the design process. For this example, assume that a sales manager would like to gain understanding of state and development of a sales pipeline over the last month in order to identify reoccurring bottlenecks, including examining the development of leads to realized sales in comparison for different regions and sub regions, through a number of states. The manager wants to identify bottlenecks, such as whether sales documents in a certain region have a slower than expected progression through states.

The manager would prefer to see in one view, the development of the sales pipeline over time and be able to navigate to any point in time to review the process in the past. For this example, the manager can select a pre-defined floor surface that supports a grouping of items in multiple categories by using slices in a circular plate. The surface also supports drill-in subcategories, by opening a slice to the full circle and showing new slices for subcategories. This surface also supports showing a state through rings towards the middle. The manager's enterprise resourcing planning (ERP) system also delivers historic data for any give date.

The manager would also like to include historic data with the help of an animated time slider, which the visualization uses to replay the development of the sales pipeline over time. As such, the manager can select pre-defined stencil objects for the selected surface. The manager can also select a data source and provide any mappings (e.g., stencil and/or surface mappings), expose events, save the visualization definition, export the visualization package, integrate, and/or distribute the associated visualization. Since the system is extensible, partners and other users can create stencils and surface objects for public and/or private uses.

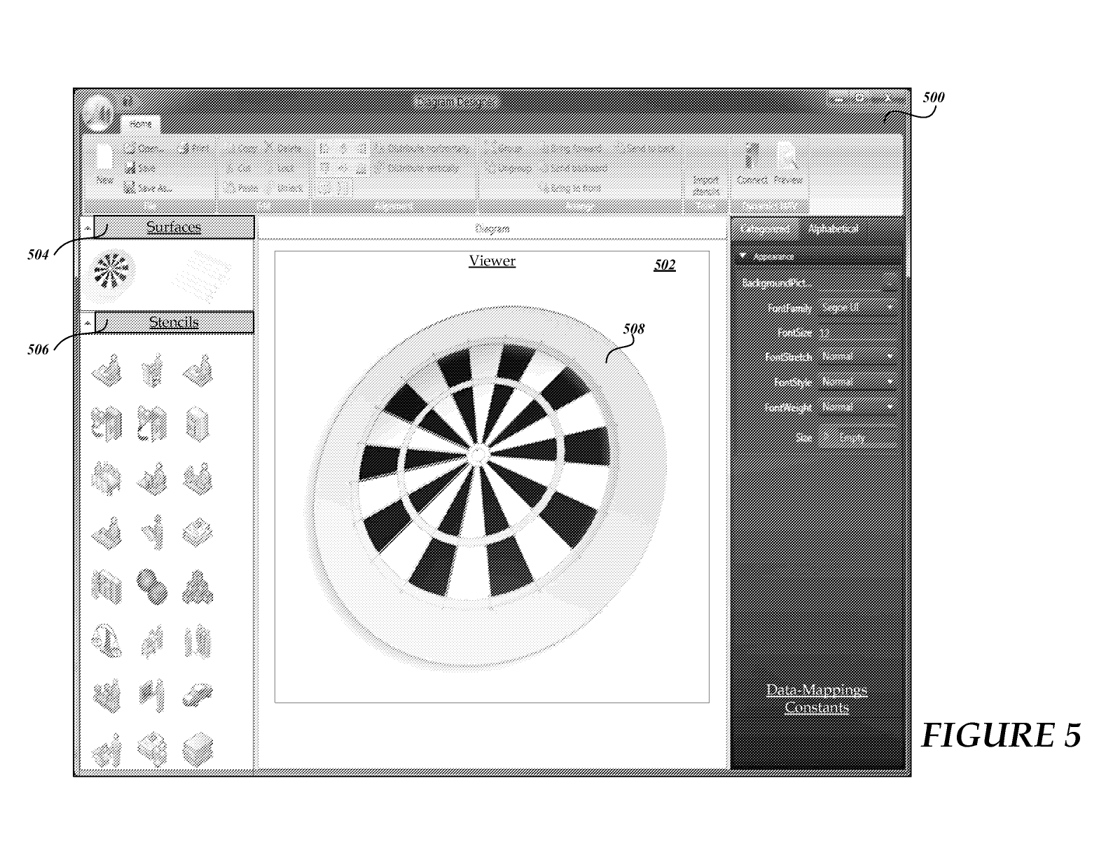

FIG. 5 depicts an exemplary visualization designer interface 500. As shown, the exemplary interface 500 of an embodiment includes a viewer portion 502, a surfaces portion 504, and a stencils portion 506. A surface preview 508 is displayed based in part on a user interaction (e.g., hover operation) with the surfaces portion 504. As shown in FIG. 5, the surfaces portion 504 includes a number of exemplary surface types and the stencils portion 506 includes a number of exemplary stencil types.

The surfaces portion 504 of an embodiment can include a plurality of selectable surface or floor types, including locally stored and/or remotely accessible surfaces. The stencils portion 506 of an embodiment can include a plurality of selectable stencil or visual element types, including locally stored and/or remotely accessible stencils. In one embodiment, additional stencils and/or surfaces can be downloaded from a designated site or provided as a program add-in. As described above, the designer application and/or interface can be used as stand-alone components and/or provided as part of a hosted application environment.

In one embodiment, a declarative design application can use the interface 500 as part of designing and providing data visualizations. For example, the interface 500 can be used to design a process or flow type visualization. A declaratively designed visualization can be provided and used as a simple design tool for an end user to create/develop process flow diagrams that are deeply integrated with an associated business application and data. For example, a declaratively designed visualization can be integrated and displayed in the context of the business application, providing the designed interactions and data visualizations (e.g., open task pages, show value indicators, etc.). A special value asset is the ability for a partner to create active surface and/or stencil libraries (e.g., using XAML/.NET). A generic import can be provided having a number of exemplary surfaces/graphics and stencils.

The interface 500 of one embodiment provides a basic visualization plane, including input options, such as pen, mouse, touch, keyboard, etc. interface for panning, rotation, zooming, and other visualization options. The interface 500 of one embodiment features a custom scene 3D model, allowing custom surface or floor models and custom stencil objects, for graphically displaying variations of each visual object as data of a visualization is manipulated and/or adjusted over some time or other quantifying period through use of quantifying indicia for the displayed objects. As described above, the declarative design framework provides a basis for a whole class of visualizations (e.g., generalized demand and supply 3D graph visualization).

Once designed and made available for use, end-users can use aspects of a pre-defined 3D data visualization, including defining a particular data source to use with the visualization and selecting the filter of data objects shown, selecting a surface and a number of stencil objects, connecting and/or selecting stencil types for various data nodes. Visualization features include graphically animating representations of direct links, dependent relations, and/or other data relationships, including changing visual representations as data and/or dependencies change. As a result, the interface 500 provides a declarative visualization design tool that allows programmers and non-programmers (e.g., experts in a business domain like Production Planners, Finance Analyzers, Supply and Delivery Planners, etc.) to define domain specific visualizations.

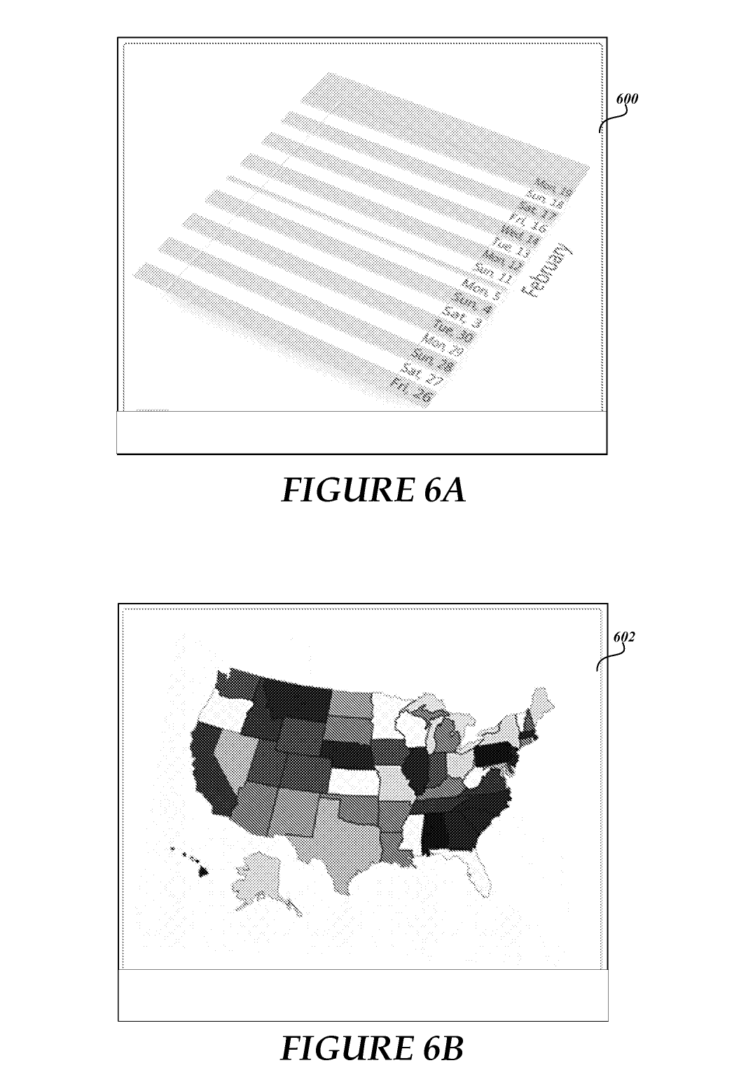

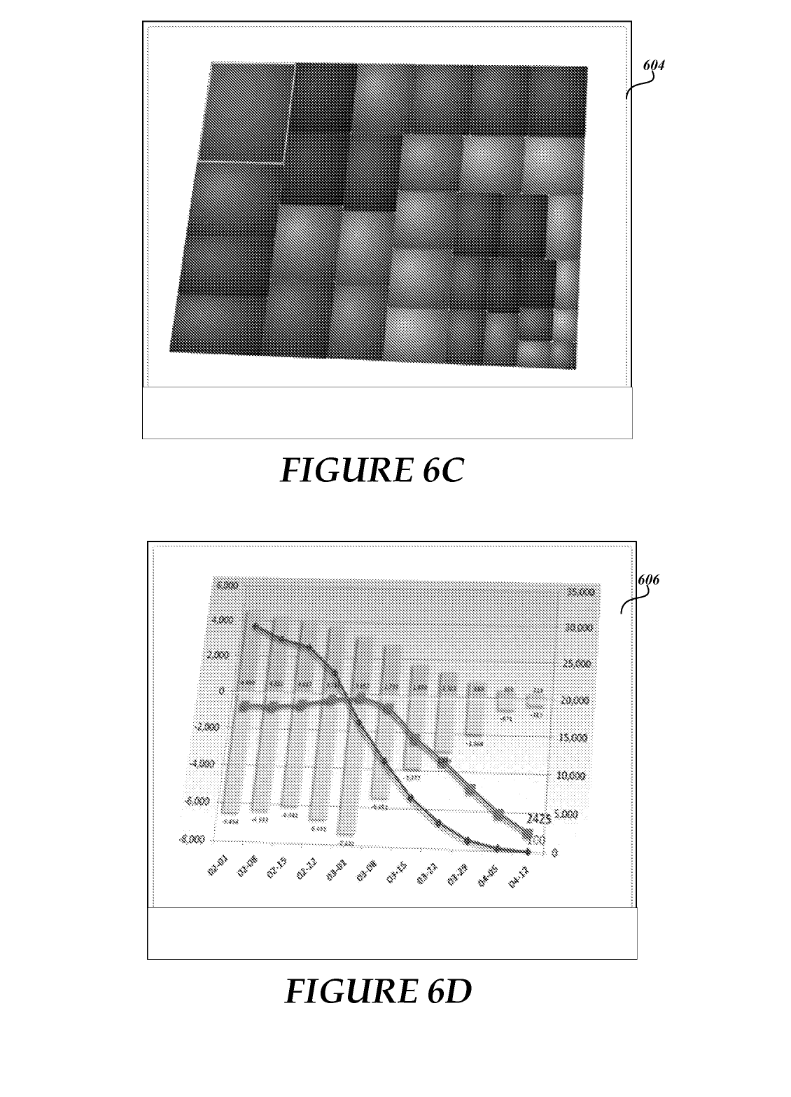

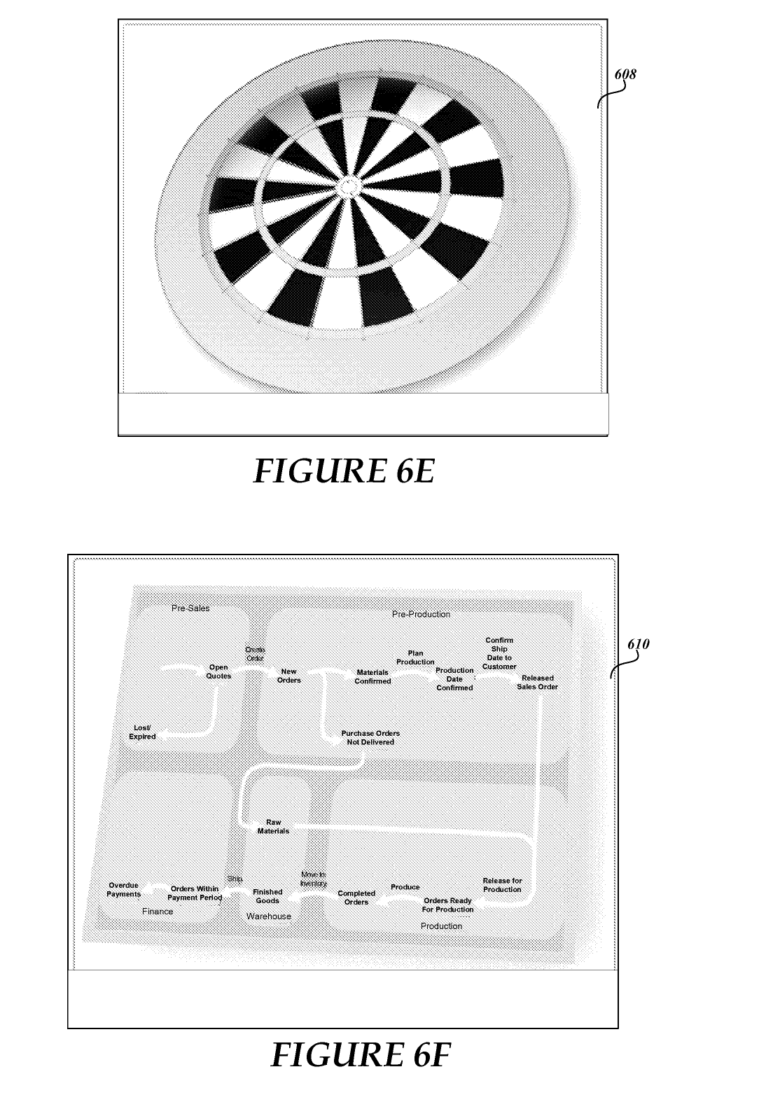

FIGS. 6A-6F depict a number of exemplary surfaces 600-610 that can be provided as surface objects for use in an interactive 3D visualization. FIG. 6A depicts an exemplary calendar-based surface 600. FIG. 6B depicts an exemplary geographically-based surface 602. FIG. 6C depicts an exemplary treemap representation surface 604. FIG. 6D depicts an exemplary graphical timeline representation surface 606, including example visual elements. FIG. 6E depicts an exemplary bulls-eye representation surface 608. FIG. 6F depicts an exemplary process or flow-based surface 610, including a number of exemplary visual elements. While a number of exemplary surfaces are shown, it will be appreciated that other surface and floor types can be designed and/or included.

FIG. 7 depicts a number of exemplary stencil or visual elements 700-714 that can be provided as stencil objects for use in an interactive 3D visualization. In one embodiment, stencil objects can be linked to data and coupled to an associated viewing surface for rendering with visual effects to visually depict aspects of the data. As shown, stencils can include different types of visual elements having various visual rendering characteristics. As shown in FIG. 7, the exemplary stencils 700-714 include stencils configured for individual data points, and stencil configured as real-world machines or products. As described above, a selected surface can be used to expose properties into visual items which are coupled to data properties that define how the visual items are to be located and/or rendered in a 3D visualization scene. While a number of exemplary stencils are shown, it will be appreciated that other stencil types can be designed and/or included.

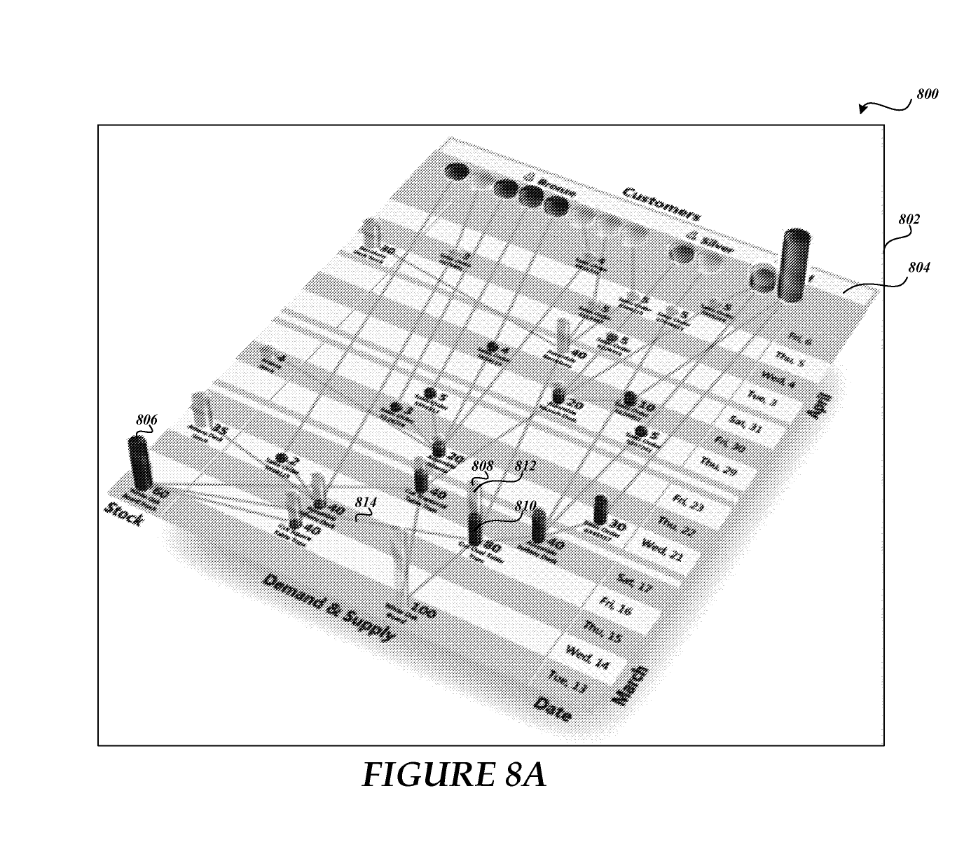

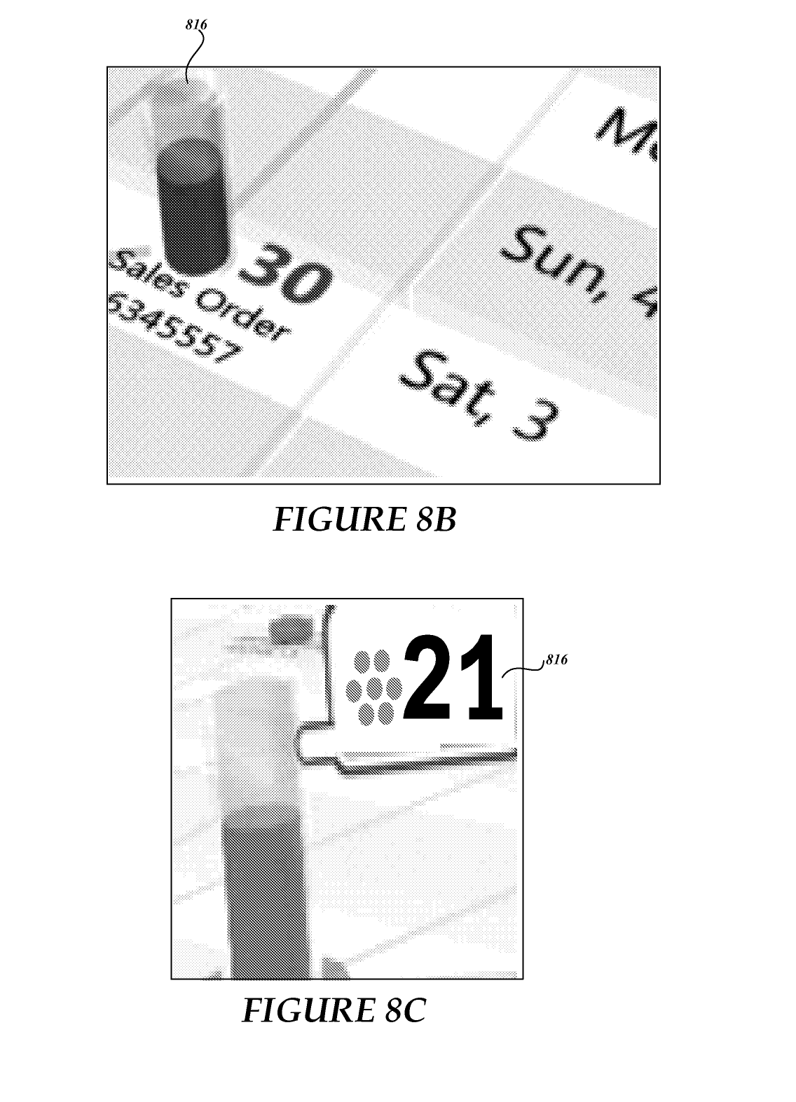

FIGS. 8A-8C depicts aspects of an exemplary interactive 3D visualization 800 provided as a result of a declarative design process. As shown, the interactive 3D visualization 800 is displayed using viewer interface 802 (controls not shown). As described below, a number of graphically rendered stencils can be dynamically displayed on the surface 804 to impart knowledge to the user based on characteristics of the underlying data driving the visualization 800. For example, advanced video and data processing resources can be used in part to dynamically render various stencil features according to linked data sets, visual properties, and/or relations between linked stencil objects.

As examples, stencil object 806 has been rendered as a cylindrical object filled with a distinct color type (e.g., blue) that corresponds with a supply parameter for a stock resource. Another color (e.g., yellow) and/or fill amount can be used to characterize a demand amount. For example, stencil object 808 includes a first fill portion 810 (e.g., supply) and a second fill portion 812 (e.g., demand). Link stencil 814 can also include visual effects (e.g., size, shape, color, fade-in/out, etc.) which can be displayed to characterize a particular relation (e.g., red when no longer a supplier) of the stencil object 806 and the stencil object 808, accounting for data dependencies for underlying data.

Sizing, fill amounts, shapes, and/or or other visual effects can be used for the displayed stencils to provide further context to the characteristics of the underlying data and/or relationships. As shown, the surface can also include additional quantifying and/or identifying information for each visual node element or stencil object (e.g., numbers to identify quantity for the stencil, text to identify a data type, etc.). The rich interactive 3D visualization 800 includes numerous link stencils connecting any number of stencils, illustrating the highly complex nature of the data relationships of the visualization.

FIG. 8B depicts a stencil object 816 after a user has zoomed into the interactive 3D visualization 800 using an interactive input.

FIG. 8C depicts the stencil object 816 and a quantifier pop-up or label (e.g., number, ratio, etc.) displayed alongside the stencil object 816 as the user interacts with the stencil object 816 (e.g., hover, right-click, etc.) or underlying data. The user can use an input device (e.g., mouse, touch screen, etc.) to scroll to a different surface point, while zooming and/or panning to focus on a particular period of time and/or a particular span of data values. Controls can be used to access macro functions for interactive charting, including create, read, update, and delete (CRUD) operations. As the user interacts with the visualization and/or a planning engine provides updates or modifications, the displayed stencil objects and/or links are automatically adjusted and updated to represent any changes.

As described above, the viewer interface 802 can be used to render the declaratively designed visualization at runtime. As shown by example, a dynamic 3D graph layout engine drives the timeline/calendar based surface and visualization scene illustrates data characteristics using partially filled flask or cylinder like visual nodes, and 3D pipe shaped link stencils. The layout engine renders the surface model, node placement, and node characteristics (e.g., filling, height, labels, etc.) based in part on input measures of the bound entities.

In particular, the interactive 3D visualization 800 of a semi-3D directed acyclic graph visualizes nodes with their respective demand and supply links to other nodes and fixed assets (like stock, destination), on a calendar type of 3D plane, with user interaction for adjusting supply levels and automatic leveling through the graph. The interactive 3D visualization 800 has rich UI manipulation for reservations (e.g., Drag & drop, sliders, select dependent graph path, highlight nodes with same input type), traverses changes through the graph, draws attention to node states (e.g., partially filled visuals), and animates all changes visually using the processing functionality of the layout engine. Visualization operations can be reflected as production orders (nodes) bubbling up to related customers who get respective orders (header area) sourced by material/items on stock (left side) sourced by supply (bottom), using a timeline track (right side). The x-axis can be defined using layout algorithms of the layout engine. At the top, the grouping includes customer groups, and therefore end nodes include a layout constraint.

While certain embodiments are described herein, other embodiments are available, and the described embodiments should not be used to limit the claims. Exemplary communication environments for the various embodiments can include the use of secure networks, unsecure networks, hybrid networks, and/or some other network or combination of networks. By way of example, and not limitation, the environment can include wired media such as a wired network or direct-wired connection, and/or wireless media such as acoustic, radio frequency (RF), infrared, and/or other wired and/or wireless media and components. In addition to computing systems, devices, etc., various embodiments can be implemented as a computer process (e.g., a method), an article of manufacture, such as a computer program product or computer readable media, computer readable storage medium, and/or as part of various communication architectures.

The term computer readable media as used herein may include computer storage media. Computer storage media may include volatile and nonvolatile, removable and non-removable media implemented in any method or technology for storage of information, such as computer readable instructions, data structures, program modules, or other data. System memory, removable storage, and non-removable storage are all computer storage media examples (i.e., memory storage.). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computing device. Any such computer storage media may be part of device.

Communication media may be embodied by computer readable instructions, data structures, program modules, or other data in a modulated data signal, such as a carrier wave or other transport mechanism, and includes any information delivery media. A modulated data signal may describe a signal that has one or more characteristics set or changed in such a manner as to encode information in the signal. By way of example, and not limitation, communication media may include wired media such as a wired network or direct-wired connection, and wireless media such as acoustic, RF, infrared, and other wireless media.

The embodiments and examples described herein are not intended to be limiting and other embodiments are available. Moreover, the components described above can be implemented as part of networked, distributed, and/or other computer-implemented environment. The components can communicate via a wired, wireless, and/or a combination of communication networks. Network components and/or couplings between components of can include any of a type, number, and/or combination of networks and the corresponding network components include, but are not limited to, wide area networks (WANs), local area networks (LANs), metropolitan area networks (MANs), proprietary networks, backend networks, etc.

Client computing devices/systems and servers can be any type and/or combination of processor-based devices or systems. Additionally, server functionality can include many components and include other servers. Components of the computing environments described in the singular tense may include multiple instances of such components. While certain embodiments include software implementations, they are not so limited and encompass hardware, or mixed hardware/software solutions. Other embodiments and configurations are available.

### Exemplary Operating Environment

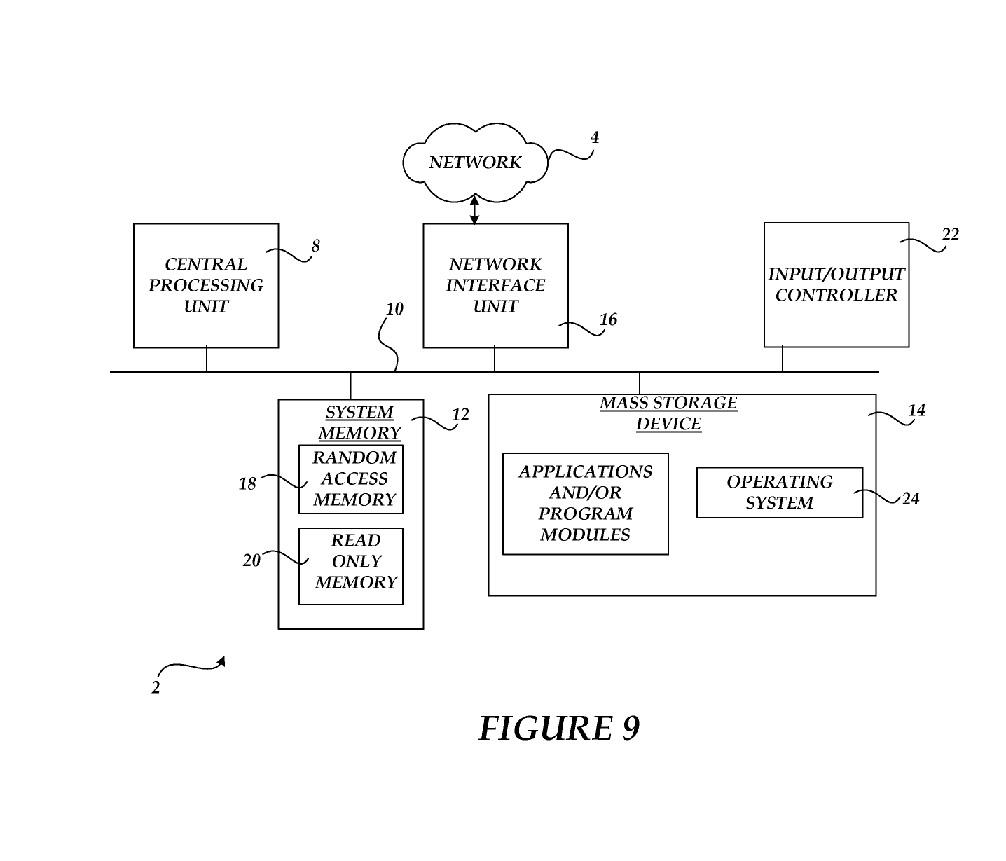

Referring now to FIG. 9, the following discussion is intended to provide a brief, general description of a suitable computing environment in which embodiments of the invention may be implemented. While the invention will be described in the general context of program modules that execute in conjunction with program modules that run on an operating system on a personal computer, those skilled in the art will recognize that the invention may also be implemented in combination with other types of computer systems and program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 9, an illustrative operating environment for embodiments of the invention will be described. As shown in FIG. 9, computer 2 comprises a general purpose server, desktop, laptop, handheld, or other type of computer capable of executing one or more application programs. The computer 2 includes at least one central processing unit 8 (“CPU”), a system memory 12, including a random access memory 18 (“RAM”) and a read-only memory (“ROM”) 20, and a system bus 10 that couples the memory to the CPU 8. A basic input/output system containing the basic routines that help to transfer information between elements within the computer, such as during startup, is stored in the ROM 20. The computer 2 further includes a mass storage device 14 for storing an operating system 24, application programs, and other program modules.

The mass storage device 14 is connected to the CPU 8 through a mass storage controller (not shown) connected to the bus 10. The mass storage device 14 and its associated computer-readable media provide non-volatile storage for the computer 2. Although the description of computer-readable media contained herein refers to a mass storage device, such as a hard disk or CD-ROM drive, it should be appreciated by those skilled in the art that computer-readable media can be any available media that can be accessed or utilized by the computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 2.

According to various embodiments of the invention, the computer 2 may operate in a networked environment using logical connections to remote computers through a network 4, such as a local network, the Internet, etc. for example. The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of other devices, including a keyboard, mouse, etc. (not shown). Similarly, an input/output controller 22 may provide output to a display screen, a printer, or other type of output device.

As mentioned briefly above, a number of program modules and data files may be stored in the mass storage device 14 and RAM 18 of the computer 2, including an operating system 24 suitable for controlling the operation of a networked personal computer, such as the WINDOWS operating systems from MICROSOFT CORPORATION of Redmond, Wash. The mass storage device 14 and RAM 18 may also store one or more program modules. In particular, the mass storage device 14 and the RAM 18 may store application programs, such as word processing, spreadsheet, drawing, e-mail, and other applications and/or program modules, etc.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A method of visualizing data comprising:
providing an interactive three-dimensional (3D) data visualization interface including a 3D visualization including a surface having a surface type and a number of stencils having one or more stencil types;
populating portions of the 3D visualization with data of one or more data types as part of displaying the data using the surface and the number of stencils defined for the 3D visualization;
automatically adjusting the display of the 3D visualization including changes to aspects of the surface and the number of stencils populating the 3D visualization associated with a change; and,
displaying the 3D visualization including controlling visual effects of one or more displayed stencils to reflect corresponding data characteristics.

2. The method of claim 1, further comprising using a visualization design component to provide the 3D visualization including declaratively selecting a particular surface and at least one stencil type for use in displaying aspects of business data.

3. The method of claim 1, further comprising using the number of stencils to populate the surface according to a visualization design definition.

4. The method of claim 1, further comprising using a visualization design component, a stencil library including a number of selectable stencils having various stencil types, and a surface library including a number of selectable surfaces having various surface types as part of a designing 3D visualizations for provisioning and use.

5. The method of claim 4, further comprising using the visualization design component to generate a visualization package including a visualization definition, and a surface and stencil dictionary used as part of providing a specific visualization experience.

6. The method of claim 5, further comprising extracting the surface and the stencils for integration into a local dictionary.

7. The method of claim 1, further comprising associating a unique identification and a version for each surface and each stencil.

8. The method of claim 1, further comprising selecting a data source to define a number, position, and process of populating the surface of the 3D visualization with the number of stencils.

9. The method of claim 1, further comprising providing the 3D visualization with a defined surface including one of a calendar surface, a map surface, and a chart surface.

10. The method of claim 9, further comprising exposing a binding contract for each surface including a number of layout properties associated with the number of stencils.

11. The method of claim 1, further comprising integrating declaratively designed 3D visualizations with a business application, including providing a visualization definition for each declaratively designed 3D visualization.

12. The method of claim 1, further comprising distributing a visualization package associated with the 3D visualization, including registering a visualization definition, and importing corresponding surface and stencil objects into associated surface and stencil libraries.

13. A visualization interface comprising:
a stencil component including a number of stencil objects having various stencil types;
a surface component including a number of surface objects having various surface types;
a visualization component for providing a 3D visualization including a display of at least one surface object and associated stencil objects, wherein data mappings are configured to drive visual stencil effects provided in the 3D visualization; and
a data source component including data having one or more data types for use in populating the 3D visualization.

14. The visualization interface of claim 13, wherein the visualization component is configured to provide visualization features including display of stencil linking objects coupled to stencil objects on an interactive visualization surface.

15. The visualization interface of claim 13, wherein a fixed contract logically couples displayed stencil objects and defines stencil object transitions for data adjustments.

16. The visualization interface of claim 13, further comprising a design component configured to generate and provide an interactive 3D visualization including a visualization package having defined stencil and surface mappings.

17. A system comprising:
a design interface configured to generate visualization packages using a declarative model, wherein each declaratively designed visualization package includes a visualization definition;
a visual node element library including a number of visual node elements;
a surface library including a number of surfaces;
a display component to display a 3D data visualization including a corresponding surface, visual node elements, and visual linking elements coupled to data of one or more data providers; and,
a display component to display the 3D data visualization.

18. The system of claim 17, further wherein the design component is further configured to use a binding contract to expose layout properties that each visual node element inherits.

19. The system of claim 17, wherein the design component is further configured to select link stencils to characterize stencil relations for the 3D data visualization.

20. The system of claim 17, wherein the visual node element library and surface library are accessible locally and remotely.
